(19) United States
(12) Patent Application Publication
(10) Pub. No.: US 2016/0053879 A1
(43) Pub. Date: Feb. 25, 2016

(54) PUMP CONTROL METHOD AND SYSTEM

(71) Applicant: PARKER-HANNIFIN CORPORATION, Cleveland, OH (US)

(72) Inventor: Blake Carl, University Heights, OH (US)

(21) Appl. No.: 14/781,343

(22) PCT Filed: Mar. 26, 2014
(86) PCT No.: PCT/US2014/031801

§ 371 Date: Sep. 30, 2015

Related U.S. Application Data
(60) Provisional application No. 61/807,504, filed on Apr. 2, 2013.
(60) Provisional application No. 61/830,711, filed on Jun. 4, 2013.

(51) Int. Cl. F16H 47/04; B60K 6/12; F16H 61/02; F04B 19/22; F04B 49/12

(52) U.S. Cl. CPC F16H 47/04; F04B 19/22; F04B 49/12; F16H 61/0202; B60K 6/12; F16H 2047/045

(57) ABSTRACT

A hydraulic hybrid vehicle 10 includes a powersplit transmission 11, a prime mover 13, a primary hydraulic pump motor unit 42, a secondary pump motor unit 43, a high pressure hydraulic accumulator 46, a planetary gear set 71, and drive wheels 15. Under certain conditions when vehicle 10 is operated at relatively higher cruising speeds, the secondary unit 43 may be hydraulically disabled by valve 55 and/or mechanically disabled by clutch 101 and/or connected to the drive wheels 15 through high gear ratio connection 101a, 101b, 79a. Also under these conditions, primary unit 42 may be oscillated or repeatedly cycled through a power additive mode in which primary unit 42 rotates in one direction to charge accumulator 46 and a power regeneration mode in which primary unit 42 rotates in the opposite direction and receives hydraulic fluid from accumulator 46.

### CROSS REFERENCE TO RELATED PATENT APPLICATIONS

This patent application claims the benefit of the filing date of U.S. provisional patent application Ser. No. 61/807,504 filed Apr. 2, 2013 and Ser. No. 61/830,711 filed Jun. 4, 2013. This patent application is related to U.S. provisional patent application Ser. No. 61/641,467 filed May 2, 2012 and international PCT patent application number PCT/2013/023048 filed Jan. 25, 2013, the disclosures of which are incorporated herein by reference in their entirety.

### TECHNICAL FIELD OF THE INVENTION

This invention relates generally to hydraulic pump control methods and systems. More specifically, this invention relates to such methods and systems for hydraulic hybrid vehicles, and to components and assemblies that may be used with such vehicles and elsewhere.

### BACKGROUND OF THE INVENTION

Hydraulic hybrid vehicles may include a vehicle prime mover such as an internal combustion engine, primary and secondary hydraulic pump motor units, at least one hydraulic energy storage device such as one or more high pressure hydraulic fluid accumulators, and isolation valves for opening and closing fluid communication between each of the pump motor units and the accumulator. The secondary pump motor unit may be used in a pumping mode to capture energy under certain conditions such as braking the vehicle, and the captured energy may be stored in the hydraulic accumulator and used by the secondary hydraulic pump motor unit to propel the vehicle in a motoring mode. The internal combustion engine and the hydraulic pump motor units may be connected to a planetary gear set, and the gear set splits power from the internal combustion engine to both power the hydraulic primary unit as well as rotate a drive shaft and propel the vehicle. A hydraulic hybrid vehicle drive system of this general type is disclosed in the above referenced PCT patent application.

When the accumulator in this type of system has a useful amount of stored energy in the form of high pressure hydraulic fluid and the vehicle is to be started from a stopped condition, the secondary pump motor unit operates in the motoring mode and uses the high pressure hydraulic fluid to start and continue moving the vehicle. In systems of this type, the secondary unit is typically connected to the drive shaft of the vehicle. Because the secondary unit is used to turn the drive shaft and propel the vehicle from a stopped condition, and because the vehicle can be fully loaded and can be in an uphill attitude in its stopped condition, a low gear ratio may be desirable between the secondary unit and the drive shaft to reduce the speed and increase the torque transmitted from the secondary unit to the drive shaft during start up and at relatively lower vehicle ground speeds.

When hydraulic power is limited or not being used, such as under cruising mode of operation, transmission of most power to drive the vehicle is through the mechanical power path rather than through the hydraulic power path. Because the rotational speed of the secondary unit is proportional to the ground speed of the vehicle due to its ring gear connection to the vehicle drive shaft, the secondary unit rotates faster as the vehicle speed increases. Due to the desired low gear ratio between the secondary unit and the drive shaft that may be provided for optimum start up and low speed torque, the secondary unit may rotate at relatively high rotational speeds particularly at higher vehicle speeds when the internal combustion engine provides most of the driving power for the vehicle during cruising mode. Because hydraulic pump motor units have a maximum allowed rotational speed due to mechanical limits of components, a technical problem is to provide the desired low gear ratio between the secondary pump motor unit and the vehicle drive shaft while still allowing relatively high maximum ground speed for the vehicle. Further, when hydraulic power is limited or not being used, technical problems include power losses in the secondary unit and maintaining a target charge in the high pressure accumulator. Further, if hydraulic power is not being used, a technical problem is dissipation of energy from hydraulic fluid pressure created by the primary pump motor unit. Additional technical problems are to provide smooth operation during all operating modes, to provide maximum energy capture and storage and utilization, to provide minimum hydraulic fluid heat build-up, to reduce system noise levels particularly at relatively higher cruising mode vehicle ground speeds, and to reduce system complexity and cost. As used herein, the term cruising mode means generally sustained vehicle speeds in excess of about 25-50 miles per hour.

### SUMMARY OF THE INVENTION

The present invention addresses the above and other technical problems in one embodiment by providing a pump control method and system that may oscillate the primary unit between a pumping mode and a motoring mode. Further, the present invention in another embodiment addresses these technical problems by changing the direction of rotation of the primary unit by changing the internal combustion engine speed while maintaining a substantially constant vehicle ground speed. Further, the present invention in another embodiment addresses these technical problems by providing a pump control method and system that may shift between enabled and disabled or shut off of the secondary unit under certain conditions. Further, the present invention in another embodiment addresses these technical problems by providing a pump control system and method that may selectively shift between a low gear range or a high gear range between the secondary unit and the vehicle drive shaft under other conditions.

According to at least one embodiment of the invention, a method of controlling a primary hydraulic pump motor unit and a secondary hydraulic pump motor unit in a vehicle hydraulic drive system for operating in a cruising mode includes providing a hydraulic drive system with a primary hydraulic pump motor unit and with a secondary hydraulic pump motor unit. An electric controller is provided with electric communication with each of the hydraulic units. The primary hydraulic unit and the secondary hydraulic unit are mechanically connected with a vehicle prime mover and with drive wheels of the vehicle through a planetary gear set. The secondary hydraulic unit is disabled during the cruising mode.

According to at least one embodiment of the invention, the disabling includes mechanically disconnecting the secondary hydraulic unit from the planetary gear set. The disconnecting may be performed by a clutch. A hydraulic energy storage device may be provided having a hydraulic energy storage capacity in fluid communication with the primary and secondary hydraulic units. The disabling may include closing fluid pressure communication between the energy storage device and the secondary hydraulic unit. The disabling may include closing fluid pressure communication between the primary hydraulic unit and the secondary hydraulic unit.

According to at least one embodiment of the invention, the primary hydraulic unit may be oscillated between a power additive mode in which the primary hydraulic unit transfers hydraulic energy to the energy storage device and a power recirculation mode in which the primary hydraulic unit transfers hydraulic energy from the energy storage device during the cruising mode while the secondary hydraulic unit is disabled. The direction of rotation of the primary hydraulic unit may be changed between one direction in the power additive mode and the opposite direction in the power recirculation mode. The rotational speed of the prime mover may be changed between one speed in the power additive mode and another speed in the power recirculation mode. The rotational speed of the prime mover may be higher in the power additive mode than in the power recirculation mode. The ground speed of the vehicle may be substantially constant during the oscillating between the power additive mode and the power recirculation mode.

According to at least one embodiment of the invention, the controller may receive inputs including energy storage device pressure and may provide outputs to change prime mover rotational speed while the vehicle is maintaining a substantially constant vehicle ground speed. The vehicle hydraulic drive system may be a hydraulic hybrid drive system. At least two different gear ratios may be provided between the secondary hydraulic unit and the drive wheels of the vehicle, with selective shifting between the different gear ratios and the disabling.

According to at least one embodiment of the invention, a method of controlling a primary and a secondary hydraulic pump motor unit in a vehicle hydraulic drive system for operating in lower speed higher torque mode and in a higher torque lower speed mode may include providing a hydraulic drive system with first and second hydraulic pump motor units and providing an electric controller with electric communication with each of the hydraulic units. The primary unit may be connected with a vehicle prime mover and with drive wheels of the vehicle through a planetary gear set. The secondary hydraulic unit may be connected through a gear shift unit to the drive wheels of the vehicle and to the planetary gear unit. The secondary hydraulic unit may be disabled during cruising mode.

According to at least one embodiment of the invention, a method of controlling a primary hydraulic pump motor unit and a secondary hydraulic pump motor unit in a vehicle hydraulic drive system for operating in a cruising mode, may include providing a hydraulic drive system with a primary hydraulic pump motor unit and with a secondary hydraulic pump motor unit and with a hydraulic energy storage device, and providing an electric controller with electric communication with each of the hydraulic units and with the hydraulic energy storage device. The primary hydraulic unit and the secondary hydraulic unit may be connected with a vehicle prime mover and with drive wheels of the vehicle through a planetary gear set. The primary hydraulic unit may be oscillated between a power additive mode in which the primary hydraulic unit transfers hydraulic energy to the hydraulic energy storage device and a power recirculation mode in which the primary hydraulic unit transfers hydraulic energy from the hydraulic energy storage device during the cruising mode at substantially constant vehicle ground speed. The direction of rotation of the primary hydraulic unit may be changed between one direction in the power additive mode and the opposite direction in the power recirculation mode. The rotational speed of the prime mover may be changed between one speed in the power additive mode and another speed in the power recirculation mode. The secondary hydraulic unit may be disabled during cruising mode. The time period for a complete power additive mode and power recirculation mode oscillation may be in the range of about 5 seconds to about 120 seconds. The discharge and recharge of the hydraulic energy storage device during the power regeneration mode and power additive mode may be in the range of about 5 percent to about 20 percent of a full storage device charge pressure. A vehicle may include the system.

According to at least one embodiment of the invention, A hydraulic drive system includes a prime mover, a primary hydraulic pump motor unit, a secondary hydraulic pump motor unit, a planetary gear set having first and second and third planetary gear components, a clutch, and an output drive shaft. The prime mover may be drivingly connected to the first planetary gear component, and the primary hydraulic unit may be drivingly connected to the second planetary gear component. The output drive shaft may be drivingly connected to the third planetary gear component. The secondary hydraulic unit may be drivingly connected to the output drive shaft and to the third planetary gear component through the clutch. The clutch may have an engaged position to drivingly connect the secondary hydraulic unit to the output shaft and to the third planetary gear component, and the clutch may have a disengaged position to disengage the secondary hydraulic unit from the output shaft and from the third planetary gear component. An electric controller may be electrically connected to the primary hydraulic unit and to the secondary hydraulic unit to set the displacement of the primary hydraulic unit and secondary hydraulic unit. The electric controller may be electrically connected to the prime mover to set the output speed of the prime mover, and the electric controller may set the displacement of the primary hydraulic unit and may set the output speed of the prime mover to rotate the primary hydraulic unit in one direction during a power additive mode during a substantially constant ground speed of the vehicle. The electric controller may set the displacement of the primary hydraulic unit and may set the output speed of the prime mover to rotate the primary hydraulic unit in the opposite direction during a power recirculation mode during the substantially constant ground speed of the vehicle. The primary hydraulic unit may pump hydraulic fluid into the hydraulic accumulator during the power additive mode, and the primary hydraulic unit may receive hydraulic fluid from the hydraulic accumulator during the recirculation mode.

### BRIEF DESCRIPTION OF THE DRAWINGS

Embodiments of this invention will now be described in further detail with reference to the accompanying drawings, in which:

FIG. 1 is a schematic diagram of a wheeled land vehicle that includes a pump control method and system according to one embodiment of the present invention;

FIG. 2 is a more detailed enlarged view of a portion of the schematic diagram illustrated in FIG. 1;

FIG. 3 is a more detailed enlarged view of a portion of the schematic diagram illustrated in FIG. 1, showing a second embodiment of the present invention;

FIG. 4 is a flow chart illustrating the method and system according to the first and second embodiments of the present invention;

FIG. 5 is a chart showing various assumed exemplary operating parameters for one exemplary operating condition of the method and system illustrated in FIG. 4;

FIGS. 6a and 6b are graphs showing various assumed exemplary operating parameters for the one exemplary operating condition of the method and system illustrated in FIG. 4;

FIGS. 7a-7f are graphs showing various actual operating parameters for one exemplary operating condition of the method and system illustrated in FIG. 4.

### DETAILED DESCRIPTION OF THE DRAWINGS

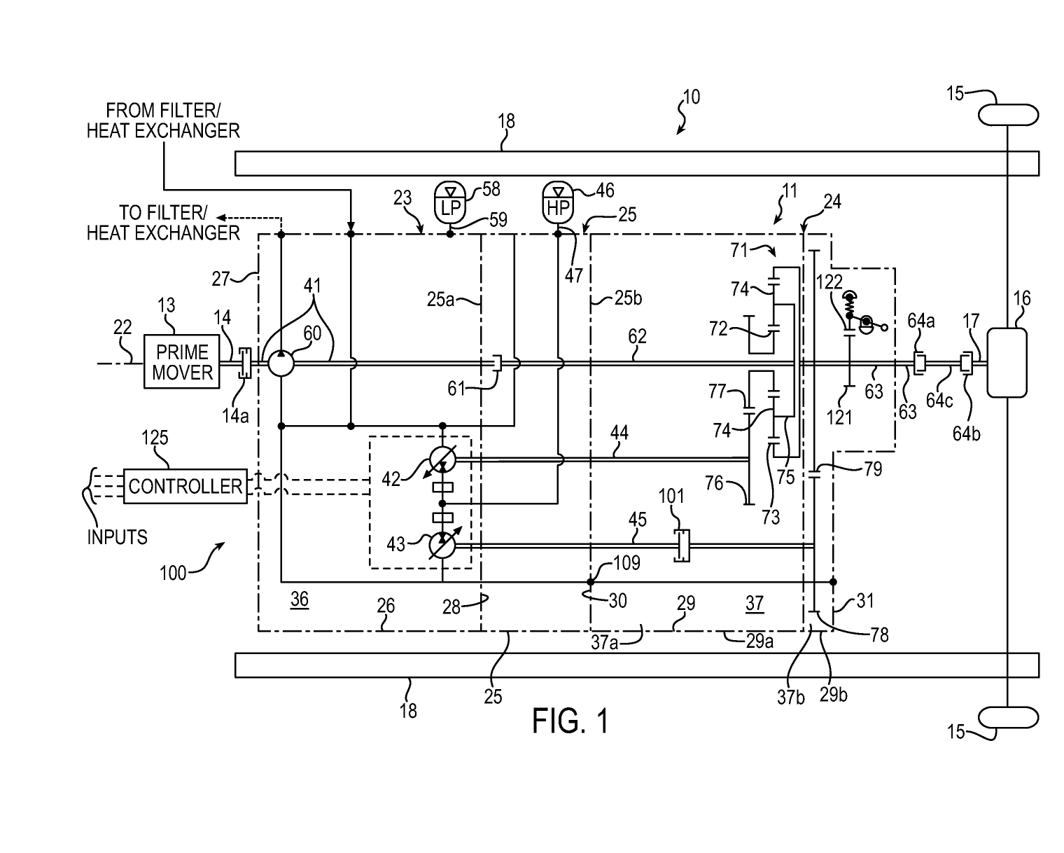

Referring now to the drawings in greater detail, FIGS. 1-4 illustrate a system 100 and method 200 according to a preferred embodiment of the present invention. The system 100 includes an object 10 having a compact hydromechanical powersplit transmission 11. The object 10 can be any object that uses a transmission for transmitting energy or converting energy to rotational movement. In the preferred embodiment described below, the object 10 is a wheeled land vehicle such as an on-highway truck. The vehicle 10 includes a prime mover 13, which in the preferred embodiment is a conventional internal combustion engine such as a gasoline or diesel or natural gas engine, and an engine drive shaft 14. The vehicle 10 further includes drive wheels 15, a differential 16, and a differential drive shaft 17. The vehicle 10 also includes frame rails 18, which are longitudinally extending beams, which may be steel or other suitable structural material, to which the body (not shown), prime mover 13, drive shaft 14, vehicle suspension components (not shown), differential 16 and other components of the vehicle 10 are mounted in a conventional well know manner.

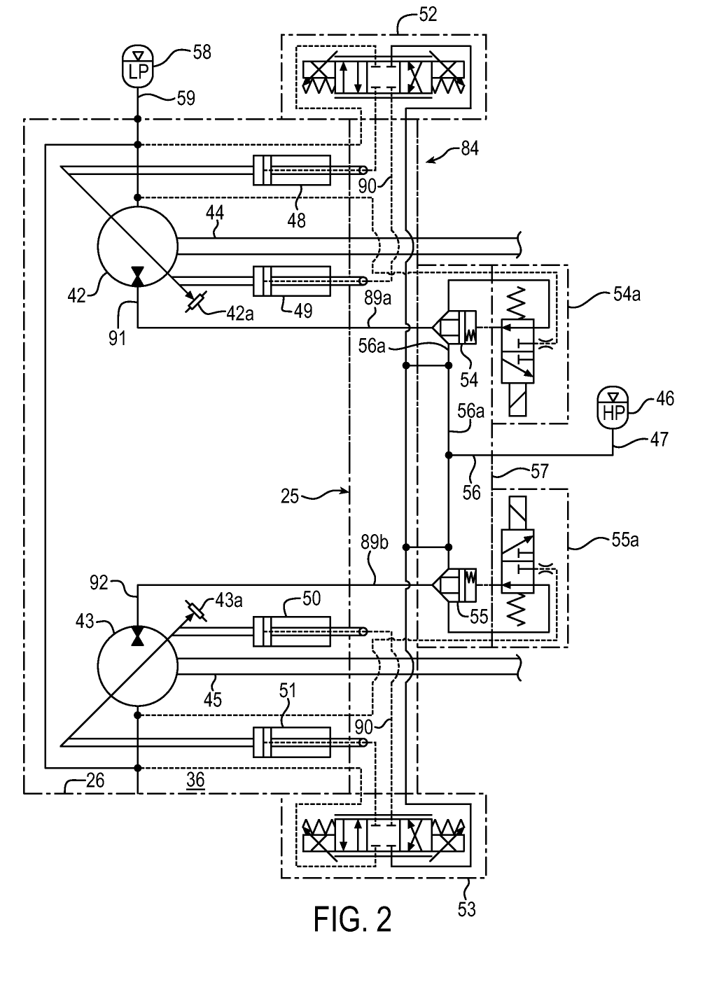

Referring to FIGS. 1-2, the hydromechanical powersplit transmission 11 has a longitudinal axis 22. The transmission 11 includes a hydraulic unit 23, a gear unit or planetary gear unit 24 that is integral with the hydraulic unit 23, and a connecting plate 25 disposed intermediate the hydraulic unit 23 and the gear unit 24. The hydraulic unit 23 includes a hydraulic unit housing 26 having a vehicle prime mover input end 27 and an output end 28. The gear unit 24 includes a gear unit housing or planetary gear unit housing 29 having an input end 30 and an output end 31. The housings 26 and 29 include chambers 36 and 37, respectively, that are sealed from one another. The chambers 36 and 37 are in longitudinally aligned relationship to one another along longitudinal axis 22, and chamber 37 includes a front chamber 47a and a rear chamber 37b. Various hydraulic connections through the chamber 36 are illustrated schematically in FIG. 1 with solid lines.

The hydraulic unit housing 26 includes a longitudinally extending prime mover input shaft or mechanical drive shaft 41 connected to engine drive shaft 14 through a suitable torsional vibration dampening coupling 14a. Input shaft 41 extends longitudinally into and through the hydraulic unit housing interior chamber 36. The input shaft 41 is rotatably connected to the prime mover 13, so that the prime mover 13 drives the input shaft 41 and causes the input shaft 41 to rotate when the prime mover 13 is running. The term rotatably connected means that components rotate together or are drivingly connected. A primary hydraulic pump motor unit 42 and a secondary hydraulic pump motor unit 43 are disposed within the chamber 36 in laterally offset spaced relation to the input shaft 41 and in circumferentially spaced relation to one another. The units 42 and 43 in the preferred embodiment are identical and are preferably bent axis, variable displacement, axial piston type pump motor units of the type disclosed in World Intellectual Property Organization publication number WO 2012/016240 A2, the disclosure of which is incorporated herein by reference. Alternatively, the size, displacement or type of the pump motor units 42 and 43 may be different from one another and/or may be different from that illustrated in the preferred embodiment. For example, primary pump motor unit 42 may be a smaller displacement unit than secondary unit 43. For brevity, the detailed structure and operation of the pump motor units 42 and 43 as disclosed in the referenced publication are not repeated in detail herein. The pump motor units 42 and 43 each operate in a pumping mode or in a motoring mode during the operation of the transmission 11, as further described below. The primary pump motor unit 42 is drivingly connected to primary pump motor unit drive shaft 44, and the secondary pump motor unit 43 is drivingly connected to secondary pump motor unit drive shaft 45. During the pumping mode, the units 42 and/or 43 are driven by primary pump motor unit drive shaft 44 and secondary pump motor unit drive shaft 45, respectively, to pump hydraulic fluid under pressure into a high pressure accumulator 46 through a hydraulic line 47 to store energy. During the motoring mode, high pressure hydraulic fluid is supplied to the units 42 and/or 43 from high pressure accumulator 46 through hydraulic line 47 to rotate the shafts 44 and 45 to convert stored energy from accumulator 46 to rotational movement.

FIG. 2 is an enlarged and more detailed schematic illustration of the portion of FIG. 1 illustrated by the dotted line box that surrounds the pump motor units 42 and 43 in FIG. 1. As illustrated schematically in FIG. 2 and as shown and described in detail in the above referenced publication, the displacement of primary pump motor unit 42 is controlled by a displacement control mechanism including setting or control pistons 48 and 49. Similarly, the displacement of secondary pump motor unit 43 is controlled by setting or control pistons 50 and 51. The primary pump motor unit control pistons 48 and 49 are set or controlled by electrohydraulic proportional control valve 52, and the secondary pump motor unit control pistons 48 and 49 are set or controlled by electrohydraulic proportional control valve 53. An isolation valve 54 is arranged to block or open fluid communication between primary pump motor unit 42 high pressure outlet 91 and a high pressure isolation valve port 56 connected to hydraulic line 47 leading to high pressure accumulator 46. An isolation valve 55 is arranged to block or open fluid communication between secondary pump motor unit 43 and high pressure isolation valve port 56. The isolation valves 54 and 55 are closed or open in response to pilot signals from electrically operated isolation pilot signal valves 54a and 55a, respectively. A low pressure reservoir 58 is connected to pump motor units 42 and 43 through low pressure hydraulic line 59 and chamber 36. A filtration and cooling pump 60 is driven by input shaft 41 and circulates hydraulic fluid from low pressure line 59 and chamber 36 to and from a hydraulic fluid filter (not shown) and a heat exchanger (not shown). Alternatively, pump 60 may be driven in any other suitable manner such as, for example, by a suitable gear set.

A coupling 61 in the connecting plate 25 couples the prime mover input shaft 41 to a transfer shaft 62, so that the input shaft 41 and transfer shaft 62 rotate together as a unit. Alternatively, coupling 61 may be in any other suitable location such as, for example, outside of and on either side of the connecting plate 25. Coupling 61 is integral to the transfer shaft 62 in the preferred embodiment but may alternatively be integral to the shaft 41 or a separate component. The transfer shaft 62 extends longitudinally from connecting plate 25 into the planetary gear housing interior chamber 37, so that the transfer shaft 62 may be considered a part of and/or an extension of input shaft 41. The right end of the transfer shaft 62 is rotatably journaled or supported in a bearing (not shown), so that the transfer shaft 62 is not drivingly coupled to the output drive shaft 63 but instead rotates relative to the output drive shaft 63. The output drive shaft 63 extends from the planetary gear unit housing interior chamber 37 longitudinally and is connected to the differential drive shaft 17 by a coupling 64a, 64b, 64c.

The planetary gear unit 24 includes gear unit components 71 disposed within the gear unit housing interior chamber 37. The gear unit components 71 are planetary gear components, and the components 71 include a sun gear 72, a ring gear 73, planet gears 74 and a planet carrier 75. The prime mover 13 is drivingly connected to the planet carrier 75. The primary pump motor unit 42 is drivingly connected to the sun gear 72. The secondary pump motor unit 43 is drivingly connected to the ring gear 73 and to the drive wheels 15. More specifically, the planet carrier 75 is drivingly connected to transfer shaft 62, preferably by a spline connection, so that transfer shaft 62 and input shaft 41 and engine drive shaft 14 and prime mover 13 are drivingly connected and rotate together. Primary pump motor unit drive shaft 44 extends into planetary gear unit interior chamber 37 and carries a gear 76 through a spline connection. Gear 76 drives gear 77, which drives sun gear 72 through a spline connection. Secondary pump motor unit drive shaft 45 is drivingly connected to ring gear 73 and to output shaft 63 and differential drive shaft 17 and differential 16 and drive wheels 15, so that these components rotate together. Specifically, secondary pump motor unit drive shaft 45 extends into planetary gear unit interior chamber 37 and carries a gear 78 through a spline connection, and gear 78 meshes with gear 79 that is connected to ring gear 73 and to output shaft 63.

The primary pump motor shaft 44 extends longitudinally from the rotating axial piston group (not shown) of its associated primary pump motor unit 42 in interior chamber 36 of hydraulic unit 23, through the connecting plate 25, and into the interior chamber 37 of planetary gear unit 24. Similarly, the secondary pump motor shaft 45 extends longitudinally from the rotating axial piston group (not shown) of its associated secondary pump motor unit 43 in interior chamber 36 of hydraulic unit 23, through the connecting plate 25, and into the interior chamber 37 of planetary gear unit 24.

The connecting plate 25 of the connecting assembly 84 provides a hydraulic manifold and further includes fluid flow passages that include high pressure fluid flow passages 89a and 89b and pilot signal passages 90. The high pressure fluid outlet side of each hydraulic pump motor unit 42 and 43 includes a high pressure fluid outlet or flow tube 91, 92, respectively, and the flow tubes 91 and 92 are further described in the above referenced WIPO publication. The passages 89a and 89b in the connecting plate 25 connect each of the isolation valves 54, 55 with an associated one of the pump motor units, so that the flow tubes 91 and 92 are each connected in fluid communication to the isolation valves 54 and 55. The valves 52, 53, 54 and 55 are secured to and mounted on the connecting plate 25, and the pilot fluid passages 90 are in fluid communication with these valves.

Turning now the operation of the transmission 11, the transmission 11 operates in various modes under a wide variety of conditions. For example, the transmission 11 operates in various modes in response to vehicle operator accelerator pedal input to transmit power from the prime mover 13 and/or from stored energy in the high pressure accumulator 46 to the differential drive shaft 17 to propel the vehicle 10. Further, the transmission 11 operates in various modes in response to vehicle operator brake pedal input to capture energy from the vehicle 10 during braking of the vehicle 10 and to transmit the captured energy to the high pressure accumulator storage device 46 for later use. Still further, the transmission 11 operates in response to vehicle operator input to start the prime mover 13 using stored energy in the accumulator storage device 46 when the vehicle 10 is stationary.

To select among a virtually infinite array of the above described operating modes of the transmission 11, the displacement and pump or motor operating mode of pump motor units 42 and 43 may be changed and the isolation valves 54 and 55 may be opened or closed. For example, when the secondary unit 43 is to be used in a pumping mode during braking to charge the accumulator 46, an input provided to the pilot valve 55a may allow the isolation valve 55 to close. In this mode of operation, the isolation valve 55 for the secondary pump motor unit 43 may act as a check valve, so that the isolation valve 55 opens when pressure in the outlet tube 92 exceeds the pressure in the high pressure accumulator 46 to allow pressure from unit 43 to charge accumulator 46. The isolation valve 54 for the primary pump motor unit 42 may be generally opened when the vehicle 10 is moving, except closed when the secondary unit 43 is pumping during braking to prevent supply of fluid from the secondary unit 43 to the primary unit 42.

When the vehicle 10 is stationary, the isolation valve 54 for the primary unit 42 may be closed, to prevent unintended flow to the secondary unit 43 and unintended movement of the vehicle 10. A parking brake gear 121 may be coupled to shaft 63, and a stationary park pawl 122 may selectively engage gear 121 to prevent rotation of shaft 63 and wheels 15 when vehicle 10 is parked. The transmission 11 may also be used to start the engine 13, to eliminate the need for a conventional starter. For this mode, hydraulic fluid from accumulator 46 is supplied to primary pump motor unit 42 and isolated from secondary pump motor unit 43, so that unit 43 and its drive shaft 44 rotate to rotate gears 76, 77, 72 and 74 to rotate planet carrier 75 and transfer shaft 62 and input shaft 41 and drive shaft 14 to rotate and start prime mover engine 13.

Further, the proportional control valves 52 and 53 adjust the displacement of the units 42 and 43 during both pumping and motoring modes. For example, when movement of vehicle 10 is initially started from a stopped position, fluid is supplied from accumulator 46 to secondary unit 43 and displacement of unit 43 is gradually increased to accelerate vehicle 10. As speed of the vehicle 10 increases and displacement of unit 43 increases, fluid pressure from accumulator 46 decreases and less stored energy is available to unit 43 to continue to drive vehicle 10. As the speed of the vehicle further increases, more power is transmitted mechanically directly from the engine 13 to driveshaft 17 through the planetary gearset 71, while less power is transmitted by the hydraulic pump motor units. By reducing the hydraulic power transmitted at higher vehicle speeds, the overall transmission efficiency is increased. Additionally, the displacements of pump motors 42 and 43 are steplessly adjusted to achieve a desired output shaft speed for a given input prime mover input shaft speed. The adjusting of displacement provides for an infinitely variable or stepless transmission ratio, which allows the prime mover 13 to be operated at its most efficient operating speed regardless of output shaft speed. Additionally, since there is no gear shifting, there is no interruption in power. When vehicle 10 is to brake, secondary unit 43 is operated in a pumping mode and displacement of unit 43 is increased to pump more fluid into accumulator 46 and cause further braking resistance to the drive wheels 15 until the desired slower speed or stopped condition for the vehicle 10 is achieved.

When hydraulic power is limited or not being used in the system 100 and method 200 according to the present invention as illustrated in FIGS. 1 and 2, such as under cruising mode of operation, transmission of most power to drive the vehicle is through the mechanical power path rather than through the hydraulic power path. Under this mode of operation, a clutch 101 in secondary drive shaft 45 as illustrated in FIG. 1 may disable secondary unit 43 by providing secondary unit disengagement or shut off. The clutch 101 may be, for example, electrically operated or hydraulically actuated using an electrohydraulic valve, or other suitable clutch mechanism. The clutch 101 is between the secondary pump motor unit 43 and ring gear 73 and between secondary pump motor unit 43 and drive shaft 17, and clutch 101 shifts secondary pump motor unit 43 between an engaged and a disengaged position or mode. Clutch 101 is engaged during normal stop and go driving, to drivingly connect these components when hydraulic power is available and secondary pump motor unit 43 is being used to provide power to propel vehicle 10. However, when hydraulic power is limited or not being used in the illustrated system 100 and method 200, for example at vehicle ground speeds over about 25 miles per hours under cruising mode of operation, clutch 101 is disengaged to disconnect secondary unit 43 from ring gear 73 and from vehicle drive shaft 17. This prevents maximum rotational speed of secondary unit 43 from being a limiting factor that would limit the top cruising speed of vehicle 10. Further, this permits a relatively low gear ratio to be used in the gears 78 and 79, so that relatively higher torque can be provided by secondary unit 43 to vehicle drive shaft 17 particularly during startup and low speed hydraulic powered operation of vehicle 10. Still further, this eliminates efficiency losses in secondary unit 43 under this mode of operation resulting from churning hydraulic fluid or volumetric loss or other losses, and reduces noise levels from secondary unit 43.

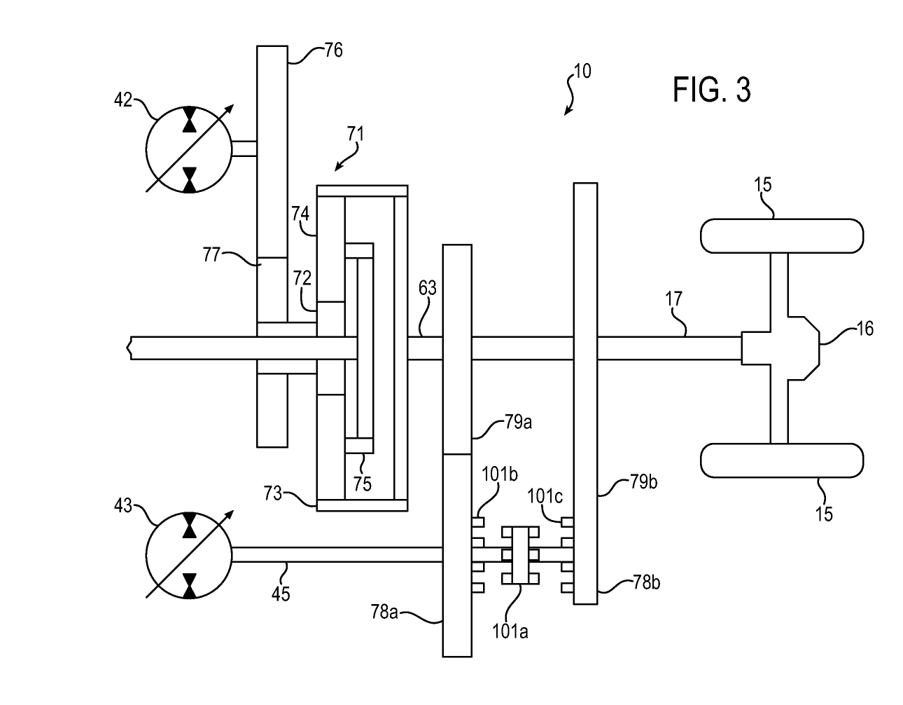

Referring now to FIG. 3, a second embodiment of the present invention provides a pump control system and method that may selectively provide disengagement or shut off of the secondary unit 43 under certain conditions as described above in connection with the embodiment of FIGS. 1-2, or a low gear range or a high gear range between the secondary unit 43 and the ring gear 73 and vehicle drive shaft 17 under various other conditions. The FIG. 3 embodiment uses the structure and method described above in connection with FIGS. 1-2, except as otherwise described. In the FIG. 3 embodiment, the gears 78 and 79 of FIG. 1 that transfer torque from the secondary unit 43 to the ring gear 73 and vehicle drive shaft 17 are replaced with gears 78a, 78b, 79a and 79b that perform this torque transfer function. Gears 78a and 79a have a number of gear teeth that engage to provide a relatively higher gear ratio (i.e., relatively higher speed transmission and relatively lower torque transmission) between secondary shaft 45 and drive shaft 17 under an operating mode further described below. Gear 78b has substantially fewer gear teeth than gear 79b, and these gear teeth engage to provide a relatively lower gear ratio (i.e., relatively lower speed transmission and relatively higher torque transmission) between secondary shaft 45 and drive shaft 17 under another operating mode as further described below. Clutch 101 of FIG. 1 is replaced with a dog clutch 101a, 101b and 101c in FIG. 3. Gears 79a and 79b of FIG. 3 are secured to shaft 63 for rotation with shaft 63 under all conditions, in the same manner as gear 79 of FIG. 1. Gears 78a and 79b are journaled on secondary shaft 45 in a manner that allows shaft 45 to rotate relative to gears 78a and 78b when gears 78a and 78b are not engaged by the dog clutch. Dog clutch center component 101a is carried on secondary shaft 45 and rotates with secondary shaft 45 under all conditions.

Dog clutch component 101a includes gear teeth on its right axial end face that selectively engage and disengage from axially facing gear teeth on the left axial end face of dog clutch component 101c carried by gear 78b. Dog clutch component 101a also includes gear teeth on its left axial end face that selectively engage and disengage from axially facing gear teeth on the right axial end face of dog clutch component 101b carried by gear 78a. Dog clutch component 101a is selectively axially movable between a first, second and third position or operating mode. The first or disengage or neutral position or mode is the position shown in FIG. 3. In this position, the dog clutch component 101a is in a center position between and disengaged from dog clutch components 101b and 101c. In this position, gears 78a and 78b are disengaged from secondary shaft 45, and the secondary unit 43 is thereby disengaged from ring gear 73 and drive shaft 17 in the manner described above when clutch 101 of FIG. 1 is disengaged. In the second or low range position or mode, dog clutch component 101a axially slides along shaft 45 to the right as viewed in FIG. 3, until the gear teeth on the right end face of component 101a drivingly engage the gear teeth on the left end face of component 101c to drivingly connect component 101c and gear 78b to secondary shaft 45, in a manner similar to that described above in connection with FIG. 1 when clutch 101 is engaged. In this position, secondary unit 43 and secondary shaft 45 are drivingly connected to vehicle drive shaft 17 through components 101a, 101c, gear 78b, and gear 79b to provide a relative low gear ratio between secondary unit 43 and vehicle drive shaft 17 for relatively lower speed and relatively higher torque transmission such as may be desired under vehicle start up conditions. Similarly, in the third or high range position or mode, dog clutch component 101a axially slides to the left from the position viewed in FIG. 3, until the gear teeth on the left end face of component 101a drivingly engage the gear teeth on the right end face of component 101b to drivingly connect components 101a and 101b and gear 78a. In this position, secondary unit 43 and secondary shaft 45 are driving connected to vehicle drive shaft 17 through components 101a, 101b, gear 78a, and gear 79a to provide a relative higher gear ratio between secondary unit 43 and vehicle drive shaft 17 for relatively lower torque and relatively higher speed transmission such as may be desired after vehicle start up conditions. If vehicle speeds in excess of design speeds for secondary unit 43 are approached, dog gear component 101a may be returned to its first or center position described above to disengage secondary unit 43 from ring gear 73 and vehicle drive shaft 17. In this manner, components 101a-101c and gears 78a and 78b provide a gear shift unit between secondary unit 43 and drive wheels 15 and between secondary unit 43 and ring gear 73 of planetary unit 71. If desired, synchronous components may be added to dog clutch 101a, 101b and 101c, and different types of clutches may alternatively be used. Also, more than two different gear ratios can be provided to provide additional operating modes. Also, dog clutch components such as 101a, 101b and 101c may be removed from shaft 45 and place on shaft 17 and used to selectively connect gears 79a and 79b to rotate with shaft 17 while gears 78a and 78b are always arranged to rotate with shaft 45.

The invention may further provide, as an alternative to or in addition to clutch 101 or to clutch 101a, 101b, 101c, a method and system in which secondary unit 43 may be disabled by shutting off secondary unit 43 from fluid communication with high pressure hydraulic accumulator 46 and/or with primary unit 42. In the embodiment illustrated in the drawings, and with particular reference to FIG. 2, this is accomplished by setting and maintaining secondary isolation valve 55 in its closed position to close fluid pressure communication between high pressure hydraulic fluid accumulator 46 and secondary unit 43 and between primary unit 42 and secondary unit 43. When this is done, even if clutch 101 is not present in the system or is present but engaged, efficiency losses in secondary unit 43 during cruising mode will be reduced and noise levels in secondary unit 43 during cruising mode will be reduced due to substantial reduction in volumetric and compressibility losses in secondary unit 43. The noise reduction is due to shutting off the high pressure connection from high pressure accumulator 46 to the secondary unit 43. When high pressure is connected to the secondary unit 43, during rotation each piston chamber of the secondary unit 43 (not shown) is connected to the high pressure line where it is filled with high pressure fluid. Subsequently in its rotation, this high pressure fluid is discharged once the chamber reaches the low pressure side of the pump. The charging/discharging of the fluid in the piston chambers is the source of noise in the secondary unit 43, and this noise source is eliminated.

Turning now to the operation of primary pump motor unit 42 during cruising mode according to method 200 and system 100, two operating principles of planetary gear set 71 are employed. One operating principle is that the torque on all three elements of the planetary gear set 71 (that is, the elements consisting of sun gear 77, planet carrier 75 and ring gear 73) maintain a constant relationship under all operating conditions, so that defining the torque on any one such element defines the torque on all three elements. The second operating principle is that defining the speed of any two of the three elements of the planetary gear set 71 defines the speed of the third element. In the method 200 and system 100 according to one embodiment of the invention, the planetary gear set 71 transmits vehicle driving torque during cruising mode from prime mover internal combustion engine 13 through shaft 62, through planet carrier 74 and ring gear 73, to vehicle drive shaft 17. In order to transmit this torque through planet carrier 74 and ring gear 73 (two of the three elements of planetary gear set 71), it is necessary to apply the same torque to sun gear 72 (the third element of planetary gear set 71). This is accomplished by electric controller 125 controlling or commanding primary pump motor unit 42 to apply or resist this torque. When primary unit 42 is applying this torque, it is necessary or desirable to rotate primary unit 42 and lubricate components of primary unit 42. In previous systems in which secondary pump motor unit 43 was not disabled, hydraulic fluid could flow from primary unit 42 through secondary unit 43 either in a pumping power additive mode or in a motoring power recirculation mode. In the system 100 and method 200 illustrated in the accompanying drawings and described herein, however, this flow through secondary unit 43 is not provided because secondary unit 43 is disabled in the manner described above.

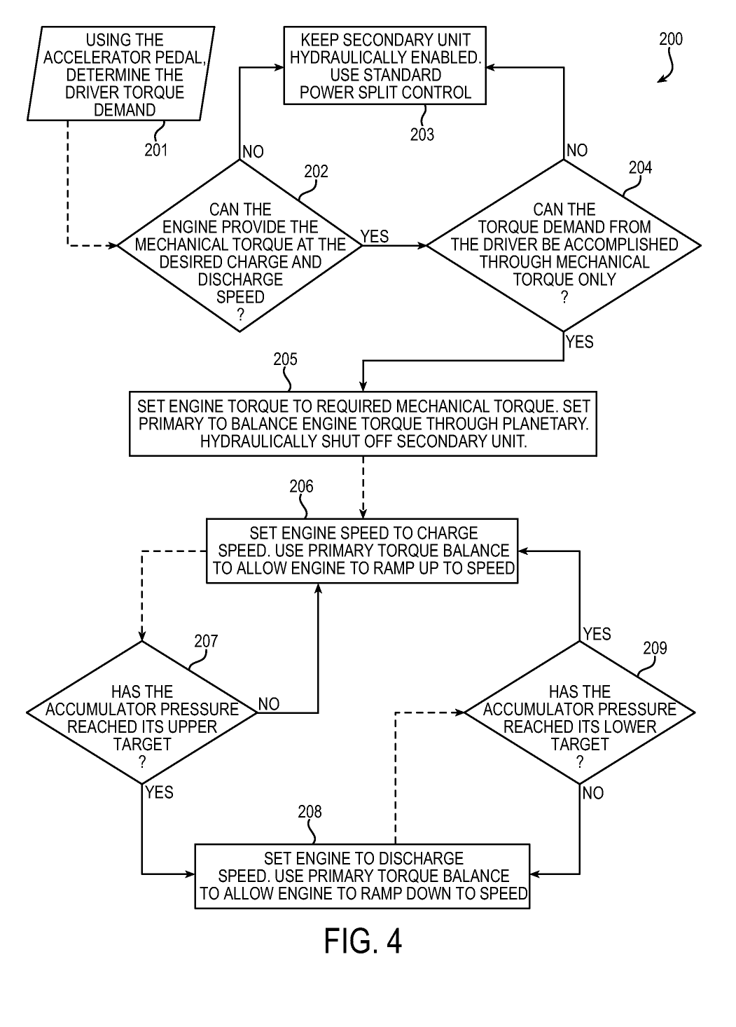

Referring now to FIG. 4, the present invention in one embodiment provides a pump control method 200 and system 100 that may oscillate the direction of rotation of the primary unit 42 and/or may oscillate the primary unit 42 between a pumping mode and a motoring mode. The method 200 and system 100 is for use when hydraulic power is limited or not being used and transmission of most power to drive the vehicle is through the mechanical power path rather than through the hydraulic power path, such as under cruising mode of operation. Further, under these conditions the present invention may provide a method 200 and system 100 that may oscillate the direction of rotation of the primary unit 42 by changing the internal combustion engine 13 speed while maintaining a substantially constant vehicle 10 ground speed. In step 201 of the method 200 and system 100, the vehicle 10 accelerator pedal receives an input as pedal movement caused by the operator of the vehicle 10 to determine a driver torque demand. In step 202, controller 125 receives inputs including speed of prime mover 13, speed of vehicle 10, high pressure accumulator 16 conditions including pressure, accelerator position, and other inputs, and determines if prime mover 13 can provide the mechanical torque at the desired high pressure accumulator 46 charge and discharge speed. If no at step 202, then at step 203 controller 125 keeps secondary unit 43 hydraulically enabled by valve 55 and uses standard power split control for mechanical torque and hydraulic torque through planetary gear set 71. At step 203, hydraulic fluid flows directly between primary unit 42 and secondary unit 43 as in previous systems. If yes at step 202, then at step 204 controller 125 determines if torque demand from the driver can be accomplished through mechanical torque only. If no at step 204, then the method 200 proceeds to described step 203 and keeps the secondary unit 203 enabled. If yes at step 204, then at step 205 controller 125 sets torque of prime mover 13 to required or demanded mechanical torque. Further, to transmit this torque through planetary gear set 71 and meet the above described planetary gear set principles, controller 125 sets primary unit 42 to balance engine torque through sun gear 72 of planetary gear set 71. At step 205, controller 125 also closes isolation valve 54 to close fluid communication between secondary unit 42 and high pressure hydraulic accumulator 46 and between secondary unit 42 and primary unit 43. Alternatively or additionally at step 205, controller 125 disengages clutch 101 or clutch 101a, 101b, 101c. Method 200 then at step 206 sets the speed of prime mover engine 13 to a charge speed to operate system 100 in a power additive mode as further described below and uses primary unit 42 to balance engine torque. At step 207, and again using the above described inputs that are monitored or used by controller 125 at all steps, controller 125 at step 207 determines if the pressure in accumulator 46 has reached an upper high pressure target pressure level. If yes at step 207, then at step 208 controller 125 changes the speed of engine 13 and sets the engine speed to a discharge speed lower than charge speed to operate system 100 in a power recirculation mode as further described below and continues to use primary unit 42 to balance engine torque to allow engine speed to ramp down. At step 209, controller 125 then determines if accumulator 46 has reached a lower pressure target. If no at step 209, then step 208 is repeated until step 209 reaches yes and method 200 proceeds back to step 206 to increase engine speed and repeat power additive mode.

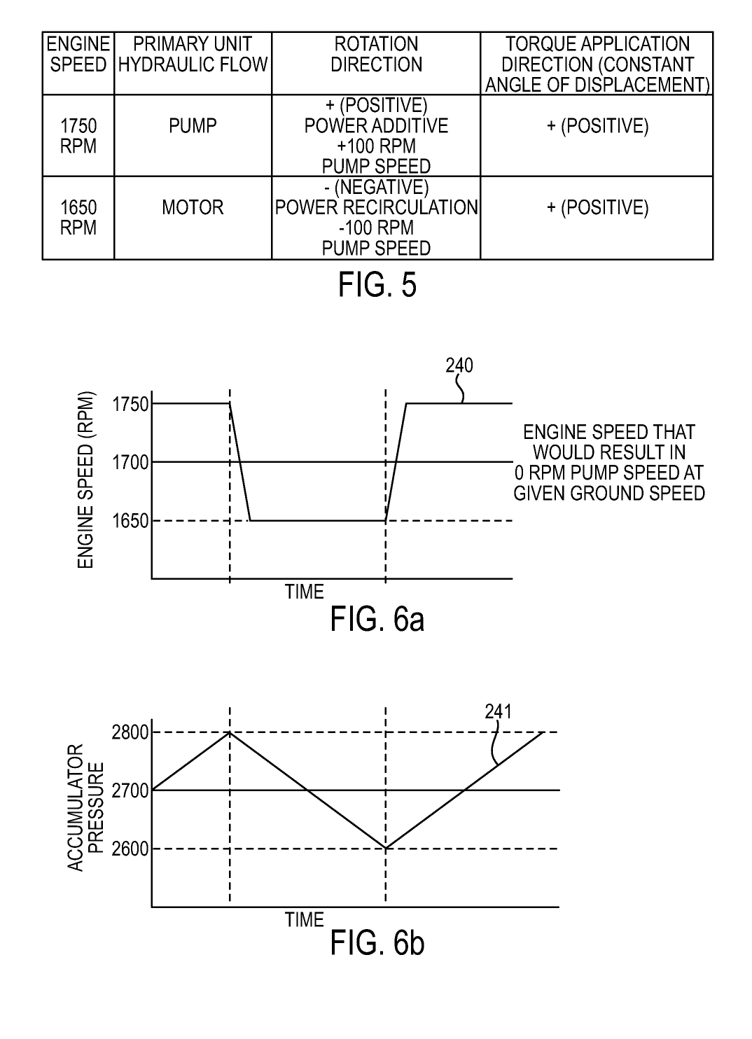

Referring now to FIG. 5 to further explain method 200 and system 100, in power additive mode at a power additive engine speed which may be a relatively higher engine speed arbitrarily indicated in FIG. 5, for example, as 1750 rpm, primary unit 42 rotates in one direction which, for example, is arbitrarily called positive direction. In the power additive mode, primary 42 charges accumulator 46. The torque by primary 42 is set by the displacement angle of the swash plate 42a of primary unit 42 and is indicated as torque value +. In power recirculation mode at a power recirculation engine speed which may be a lower engine speed arbitrarily indicated in FIG. 5 for example as 1650 rpm, primary unit 42 rotates in the opposite direction which for example is arbitrarily called negative direction. In the power recirculation mode, primary unit 42 discharges accumulator 46. The torque by primary unit 42 is set by the displacement angle of the swash plate 42a of primary unit 42 and is indicated as torque value +, which remains substantially constant as the method 200 and system 100 operates in the power additive mode and power recirculation mode. Rotational direction of primary unit 42 can change as method 200 and system 100 oscillates between power additive mode and power recirculation mode, based upon the above mentioned operating principles of planetary gear set 71. Vehicle ground speed and speed of ring gear 73 is substantially constant during the described oscillation, and these substantially constant speeds are maintained as engine speed (and its associated planet carrier speed) is increased or decreased and as accompanying primary unit 42 speed (and its associated sun gear speed) moves from positive to negative.

FIG. 6a further illustrates with line 240 how engine speed (revolutions per minute) changes from power additive mode engine speed to power recirculation mode engine speed. FIG. 6b further illustrates with line 241 how high pressure accumulator 46 pressure (pounds per square inch) changes from power additive mode to power recirculation mode as FIG. 6a engine speed changes. The horizontal time axes on FIGS. 6a and 6b are identical, so that FIGS. 6a and 6b together illustrate the relationship between engine speed and accumulator pressure for assumed exemplary conditions. During power additive mode, engine speed (1700 rpm, for example) and positive primary unit 42 rotation direction, accumulator 46 pressure builds to the upper target (2800 psi, for example) during above described step 206 until the upper target is reached at step 207. During power recirculation mode engine speed (1650 rpm, for example) and negative primary unit 42 rotation direction, accumulator 46 pressure decreases to the lower target (2600 psi, for example) during above described step 208 until the lower target is reached at step 209. If engine 13 were operated at the midpoint (1700 rpm, for example) between power additive engine speed and power recirculation engine speed, primary unit 42 speed would be substantially zero, but this condition is avoided to continue to rotate and continue to lubricate primary unit 42. The time period for the power additive mode and for the power recirculation mode are dependent upon the time it takes to move between the higher and the lower target pressures for the accumulator 46, and the time period is dependent upon the size and pressure of the accumulator 46 and system operating conditions. The time period for a complete power additive mode and power recirculation mode cycle or oscillation may preferably be in the range of about 5 seconds to about 120 seconds. In one actual example further discussed below, the method 200 and system 100 have about two cycles during each 50 second time period at a substantially constant vehicle ground speed of 68 miles per hour. The discharge and recharge of the accumulator 46 during the power regeneration mode and power additive mode, respectively, may preferably be in the range of about 5 percent to about 20 percent of a full accumulator charge pressure. In the example further discussed below, the method 200 and system 100 discharge and recharge the accumulator 46 is in the range of about 200 psi, or less than about 10 percent of a full accumulator charge pressure.

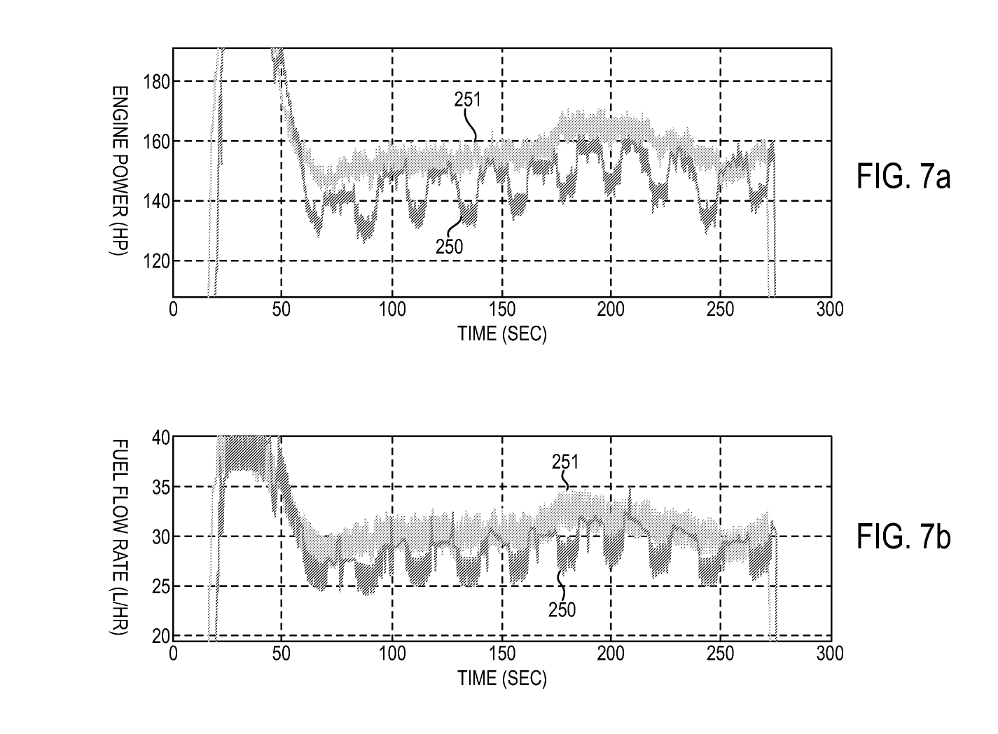

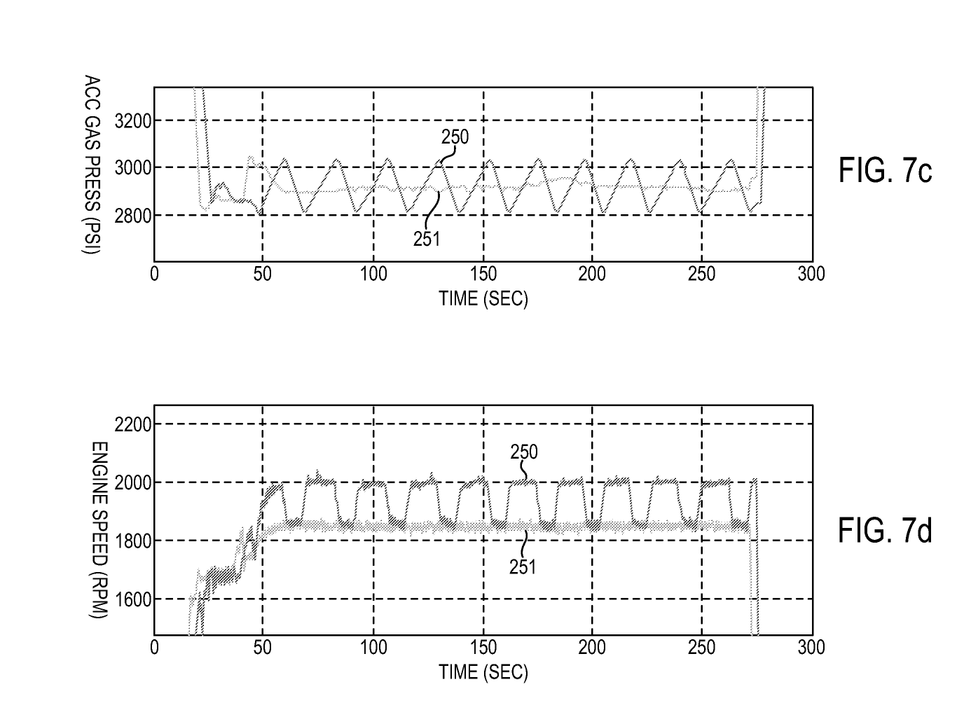

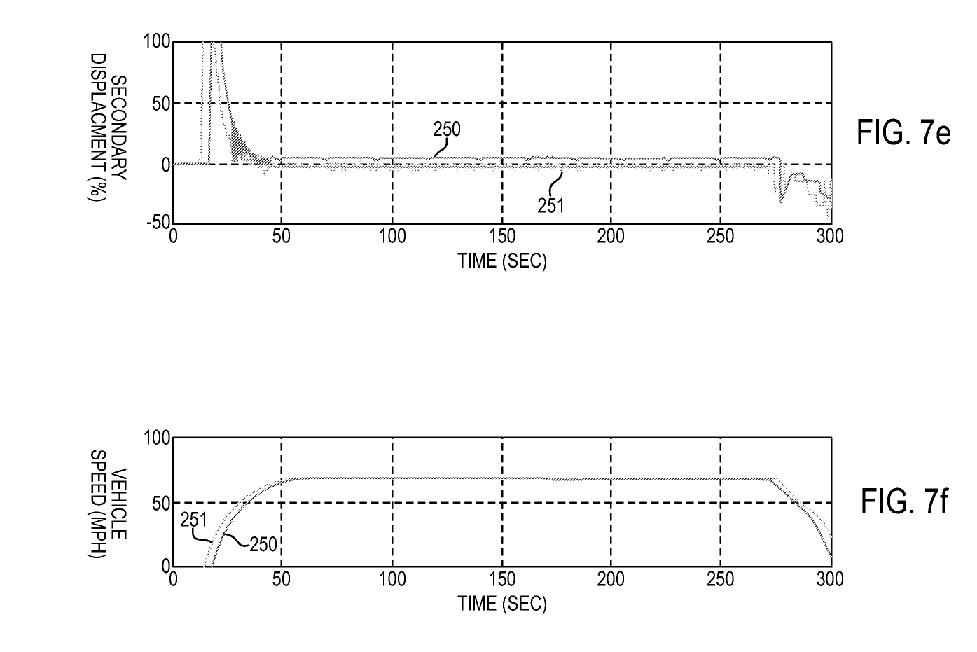

One actual operating condition for method 200 and system 100 is illustrated in FIGS. 7a-7f. FIGS. 7a-7f compare this operating condition which is indicated by lighter lines 250 in FIGS. 7a-7f, to a previous operating condition which is indicated by darker lines 251 in FIGS. 7a-7f. In the previous operating condition, primary unit 42 is not cycled between a power additive and power recirculation mode and secondary unit 43 is enabled. In illustrated method 200 and system 100, and in illustrated previous method and system, vehicle ground speed is maintained at a substantially constant 68 mph. The horizontal time axes on FIGS. 7a-7f are identical, so that FIGS. 7a-7f together illustrate the relationship between the measured parameters for the indicated conditions.

In FIG. 7a, instruments on the vehicle 10 recorded engine power. The darker lines 251 show higher mean or average engine power needed to maintain 68 mph in the previous method and system, and the lighter lines 250 show less mean or average engine power needed to maintain 68 mph in method 200 and system 100 according one embodiment of the present invention. The lighter lines 250 also show how in the method 200 and system 100 engine power oscillates between higher power when in the power additive mode in which accumulator 46 is being charged and lower power when in the power recirculation mode in which accumulator 46 is being discharged. The method 200 and system 100 as illustrated in FIG. 7a reduces mean or average engine 13 horsepower to maintain the same vehicle 10 speed, and this engine horsepower reduction provides an increase in vehicle operating efficiency and an increase in miles per gallon of fuel. Similar graphs may be shown for other vehicle ground speeds to show that reductions in mean or average engine horsepower are also achieved at lower vehicle ground speeds. Greater reductions are achieved at higher vehicle 10 ground speeds while lesser reductions are achieved at lower vehicle 10 ground speeds.

Other operating parameters for the method 200 and system 100 and for the previous system are illustrated in FIGS. 7b-7f. FIG. 7b illustrates fuel flow rates, and FIG. 7c illustrates pressure in the accumulator 46. FIG. 7d illustrates engine speed, which is substantially constant for the darker lines 251 of the previous method and system and which oscillates for the lighter lines 250 of the method 200 and system 100. FIG. 7e illustrates in the lighter lines 250 and in the darker lines 251 that the displacement of the secondary unit 43 for the method 200 and system 100, and for the previous method and system, approaches zero. FIG. 7f shows that the 68 mph vehicle ground speed was maintained during the described operations.

In another alternative of the method 200 and system 100, the vehicle speed can be changed while the primary unit 42 oscillates between its power additive and power recirculation modes. In this example, the drive torque on the output shaft can be varied by increasing or decreasing the engine torque based upon operator input on the accelerator pedal. By varying the drive torque (and therefore power) the speed of the vehicle 10 can be increased or decreased. In this example, the controller 125 oscillates the primary unit 42 in the manner described above during changes of vehicle speed.

The above described method and system may also be incorporated in other types of vehicles and other types of drive systems. For example, the functionality of hydraulically or mechanically disconnecting or disabling the secondary unit may be used in a non-hybrid power split hydrostatic transmission without a hydraulic accumulator as well. That system could include, for example, a planetary gear set, vehicle drive wheels connected to one component of the planetary gear set, a prime mover engine connected to a second component of the planetary gear set, a first hydraulic unit connected to a third component of the planetary gear set, a second hydraulic unit connected to the vehicle drive wheels and the one component of the planetary gear set, and a disabling mechanism such as, for example, a clutch for disabling the second hydraulic unit under cruising conditions and/or a shifting arrangement.

Although the principles, embodiments and operation of the present invention have been described in detail herein, this is not to be construed as being limited to the particular illustrative forms or examples disclosed. It will thus become apparent to those skilled in the art that various modifications of the embodiments herein can be made without departing from the spirit or scope of the invention.

1. A method of controlling a primary hydraulic pump motor unit and a secondary hydraulic pump motor unit in a vehicle hydraulic drive system for operating in a cruising mode, comprising the steps:
providing a hydraulic drive system with a primary hydraulic pump motor unit and with a secondary hydraulic pump motor unit;
providing an electric controller with electric communication with each of the hydraulic units;
mechanically connecting the primary hydraulic unit and the secondary hydraulic unit with a vehicle prime mover and with drive wheels of the vehicle through a planetary gear set; and
disabling the secondary hydraulic unit during the cruising mode.

2. A method as set forth in claim 1, wherein the disabling includes mechanically disconnecting the secondary hydraulic unit from the planetary gear set.

3. A method as set forth in claim 2, wherein the disconnecting is performed by a clutch.

4. A method as set forth in claim 1, including providing a hydraulic energy storage device having a hydraulic energy storage capacity in fluid communication with the primary and secondary hydraulic units.

5. A method as set forth in claim 4, wherein the disabling includes closing fluid pressure communication between the energy storage device and the secondary hydraulic unit.

6. A method as set forth in claim 4, wherein the disabling includes closing fluid pressure communication between the primary hydraulic unit and the secondary hydraulic unit.

7. A method as set forth in claim 1, including oscillating the primary hydraulic unit between a power additive mode in which the primary hydraulic unit transfers hydraulic energy to the energy storage device and a power recirculation mode in which the primary hydraulic unit transfers hydraulic energy from the energy storage device during the cruising mode while the secondary hydraulic unit is disabled.

8. A method as set forth in claim 7, including changing the direction of rotation of the primary hydraulic unit between one direction in the power additive mode and the opposite direction in the power recirculation mode.

9. A method as set forth in claim 7, including changing the rotational speed of the prime mover between one speed in the power additive mode and another speed in the power recirculation mode.

10. A method as set forth in claim 9, wherein the rotational speed of the prime mover is higher in the power additive mode than in the power recirculation mode.

11. A method as set forth in claim 7, including maintaining the ground speed of the vehicle substantially constant during the oscillating between the power additive mode and the power recirculation mode.

12. A method as set forth in claim 11, wherein the controller receives inputs including energy storage device pressure and provides outputs to change prime mover rotational speed while the vehicle is maintaining a substantially constant vehicle ground speed.

13. A method as set forth in claim 7, including changing the ground speed of the vehicle during the oscillating between the power additive mode and the power recirculation mode.

14. A method as set forth in claim 13, wherein the controller receives inputs including energy storage device pressure and provides outputs to change prime mover rotational speed while the vehicle is changing its ground speed.

15. A method as set forth in claim 1, wherein the controller provides outputs to control the displacement and torque of the primary hydraulic unit.

16. A method according to claim 1, wherein the vehicle hydraulic drive system is a hydraulic hybrid drive system.

17. A method according to claim 1, further including providing at least two different gear ratios between the secondary hydraulic unit and the drive wheels of the vehicle, and selectively shifting between the different gear ratios and the disabling.

18. A method of controlling a primary and a secondary hydraulic pump motor unit in a vehicle hydraulic drive system for operating in lower speed higher torque mode and in a higher speed lower torque mode, comprising the steps:
providing a hydraulic drive system with first and second hydraulic pump motor units;
providing an electric controller with electric communication with each of the hydraulic units;
mechanically connecting the primary unit with a vehicle prime mover and with drive wheels of the vehicle through a planetary gear set;
mechanically connecting the secondary hydraulic unit through a gear shift unit to the drive wheels of the vehicle and to the planetary gear unit.

19. A method as set forth in claim 18, including disabling the secondary hydraulic unit during cruising mode.

20. A method of controlling a primary hydraulic pump motor unit and a secondary hydraulic pump motor unit in a vehicle hydraulic drive system for operating in a cruising mode, comprising the steps:
providing a hydraulic drive system with a primary hydraulic pump motor unit and with a secondary hydraulic pump motor unit and with a hydraulic energy storage device;
providing an electric controller with electric communication with each of the hydraulic units and with the hydraulic energy storage device;
mechanically connecting the primary hydraulic unit and the secondary hydraulic unit with a vehicle prime mover and with drive wheels of the vehicle through a planetary gear set,
oscillating the primary hydraulic unit between a power additive mode in which the primary hydraulic unit transfers hydraulic energy to the hydraulic energy storage device and a power recirculation mode in which the primary hydraulic unit transfers hydraulic energy from the hydraulic energy storage device during the cruising mode at substantially constant vehicle ground speed, and
changing the direction of rotation of the primary hydraulic unit between one direction in the power additive mode and the opposite direction in the power recirculation mode.

21. A method as set forth in claim 20, including changing the rotational speed of the prime mover between one speed in the power additive mode and another speed in the power recirculation mode.

22. A method as set forth in claim 21, wherein the rotational speed of the prime mover is higher in the power additive mode than in the power recirculation mode.

23. A method as set forth in claim 20, including disabling the secondary hydraulic unit during cruising mode.

24. A method as set forth in claim 1, wherein the time period for a complete power additive mode and power recirculation mode oscillation is in the range of about 5 seconds to about 120 seconds.

25. A method as set forth in claim 4, wherein the discharge and recharge of the hydraulic energy storage device during the power regeneration mode and power additive mode is in the range of about 5 percent to about 20 percent of a full storage device charge pressure.

26. A system having the components and being connected for performing the method according to claim 1.

27. A vehicle including the system of claim 26.

28. A vehicle hydraulic drive system comprising a prime mover, a primary hydraulic pump motor unit, a secondary hydraulic pump motor unit, a planetary gear set having first and second and third planetary gear components, a clutch, and an output drive shaft,
the prime mover being drivingly connected to the first planetary gear component, the primary hydraulic unit being drivingly connected to the second planetary gear component, the output drive shaft being drivingly connected to the third planetary gear component,
the secondary hydraulic unit being drivingly connected to the output drive shaft and to the third planetary gear component through the clutch, the clutch having an engaged position to drivingly connect the secondary hydraulic unit to the output shaft and to the third planetary gear component, and the clutch having a disengaged position to disengage the secondary hydraulic unit from the output shaft and from the third planetary gear component.

29. A vehicle hydraulic drive system as set forth in claim 28, including an electric controller, the electric controller being electrically connected to the primary hydraulic unit and to the secondary hydraulic unit to set the displacement of the primary hydraulic unit and secondary hydraulic unit, the electric controller being electrically connected to the prime mover to set the output speed of the prime mover, the electric controller setting the displacement of the primary hydraulic unit and setting the output speed of the prime mover to rotate the primary hydraulic unit in one direction during a power additive mode during a substantially constant ground speed of the vehicle, and the electric controller setting the displacement of the primary hydraulic unit and setting the output speed of the prime mover to rotate the primary hydraulic unit in the opposite direction during a power recirculation mode during the substantially constant ground speed of the vehicle.

30. A vehicle hydraulic drive system as set forth in claim 28, including a hydraulic accumulator, the primary hydraulic unit pumping hydraulic fluid into the hydraulic accumulator during the power additive mode, and the primary hydraulic unit receiving hydraulic fluid from the hydraulic accumulator during the recirculation mode.

31. A vehicle hydraulic drive system comprising a prime mover, a primary hydraulic pump motor unit, a secondary hydraulic pump motor unit, a planetary gear set having first and second and third planetary gear components, an electric controller, and an output drive shaft,
the prime mover being drivingly connected to the first planetary gear component, the primary hydraulic unit being drivingly connected to the second planetary gear component, the output drive shaft being drivingly connected to the third planetary gear component,
the secondary hydraulic unit being drivingly connected to the output drive shaft and to the third planetary gear component,
the electric controller being electrically connected to the primary hydraulic unit and to the secondary hydraulic unit to set the displacement of the primary hydraulic unit and secondary hydraulic unit, the electric controller being electrically connected to the prime mover to set the output speed of the prime mover, the electric controller setting the displacement of the primary hydraulic unit and setting the output speed of the prime mover to rotate the primary hydraulic unit in one direction during a power additive mode during a substantially constant ground speed of the vehicle, and the electric controller setting the displacement of the primary hydraulic unit and setting the output speed of the prime mover to rotate the primary hydraulic unit in the opposite direction during a power recirculation mode during the substantially constant ground speed of the vehicle.

32. A vehicle hydraulic drive system as set forth in claim 31, including a hydraulic accumulator, the primary hydraulic unit pumping hydraulic fluid into the hydraulic accumulator during the power additive mode, and the primary hydraulic unit receiving hydraulic fluid from the hydraulic accumulator during the recirculation mode.

33. A vehicle hydraulic drive system as set forth in claim 32, including a disabling mechanism to disable the secondary pump motor unit during the vehicle constant ground speed as the primary hydraulic pump motor unit oscillates between the additive mode and the recirculation mode.
